(19) United States
(12) Patent Application Publication
(10) Pub. No.: US 2004/0178874 A1
(43) Pub. Date: Sep. 16, 2004

(54) Planar channel inductance

(76) Inventor: Erich Maximilian Kaifler, Taufkirchen (DE)

Correspondence Address: Erich Kaifler, c/o B. and R. Dater, 5305 Barouche Ct., Plano, TX, 75023, US

(21) Appl. No.: 10/447,240

(22) Filed: May 27, 2003

(30) Foreign Application Priority Data
Mar. 14, 2003 (DE) 103 11 330.4

(51) Int. Cl. H01F 5/00

(52) U.S. Cl. 336/200

(57) ABSTRACT

Compact low profile inductive devices, such as coils, transformers, generators etc. with a soft magnetic pipe or channel (M) etc. (core) of small diameter and thus short magnetic path, and long effective wire length. The length of the effective wire is determined by the length of the channel and/or by the number of turns (L). To form the windings it is also possible to use planar tracks (L) on a substrate (P) like e.g. a PCB. Some of the inductive components consist of vertically split windings, which are completed again, with the magnetic circuit around it. At (SST) the windings are sawn through and completed again. (W) are windows in the substrate for the magnetic circuits (M).

Bobbin coils are not necessary.

In other cases windings are formed by connecting the end of a wire loop to the beginning of the next loop etc.

The inductance can be part of the circuit board, it can be integrated into a substrate so that e.g. all the PCB area is avilable for other comonents. It also can be designed as a stand alone component.

A: Load Circuits

For the magnetic circuit of the described inductive units any soft magnetic material can be used (like e.g. Fe, Ferrite, NiFe alloys). Even for inductive devices without air gap it is not necessary to split the core in order to complete it with the (bobbin) coil. As a result materials of very high permeability can be used and thus electrical data can be achieved which are superior to conventional wire wound designs of today.

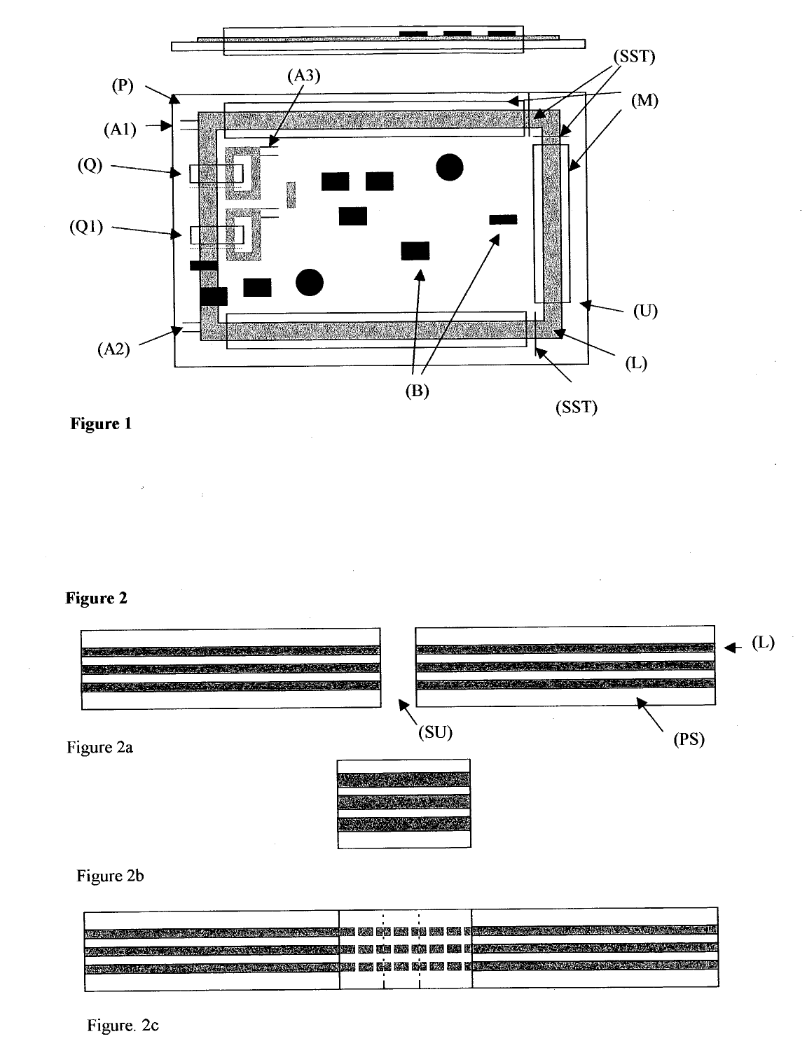

FIG. 1 shows a board with various components (B), a transformer (U) with 3 magnetic circuits (M) and the pins for the primary (A1) and secondary (A2). Tracks and windings resp. (L) are on a substrate or are integrated into the board; however it is also possible to use standard wire leads etc. They are inside the (M) magnetic circuits (channels, pies etc.)

In order to get high packing density using Survace Mount Technology, the components (B) can be placed above tracs and magnetic circuits as well.

To fully take advantage of the features of the soft magnetic material, conventional designs require “threading” the windings in order to get the desired magnetic flux

θ=I·N and the magnetic field strength

θ/1, which however for technical and economical reasons in many cases is not practical. To split (sawing through etc.) the coil and to put it together again was for practical reasons in most cases out of question. The here described solution however is just making use of this concept, which with modern equipment is well possible.

In many cases planar coils may be preferred, which can be in or on ceramic substrates, PCB'S, foils, semiconductors etc. Coils of such techologies can be split (sawn etc.) into two sections. FIG. 2 e.g. shows a board (PS) with conductive tracs (L) sawn through (SST). FIG. 2b shows the appropriate connecting part in “up side down” technique.

In FIG. 2c the connecting part is adjusted onto the tracs and connected by a temperature process and/or by pressure and/or vibration etc.

(Q) and (Q1) are simple auxiliary inductors (FIG. 1) for auxiliary power supplies, starter circuits, standby operation etc. which are formed by additional magnetic circuits and the windings (L) on board (P) and additional sekundary windings as shown.

The thin rectangle (full line) represents the magnetic circuit, the thicker rectangle the secondary winding with connection pins (A3) etc.

The dashed line shows where the windings are sawn through, so that the soft magnetic channel, pipe etc. can be mounted.

To get best electrical performance such units, opimized in respect to application and material, can be used for the circuit any way (in parallel, in series etc.).

Two layer coils can be made by using both sides of the substrate. The substrate functiones also as an ideal insulator whose data can be set by quality and thicknes of the material used.

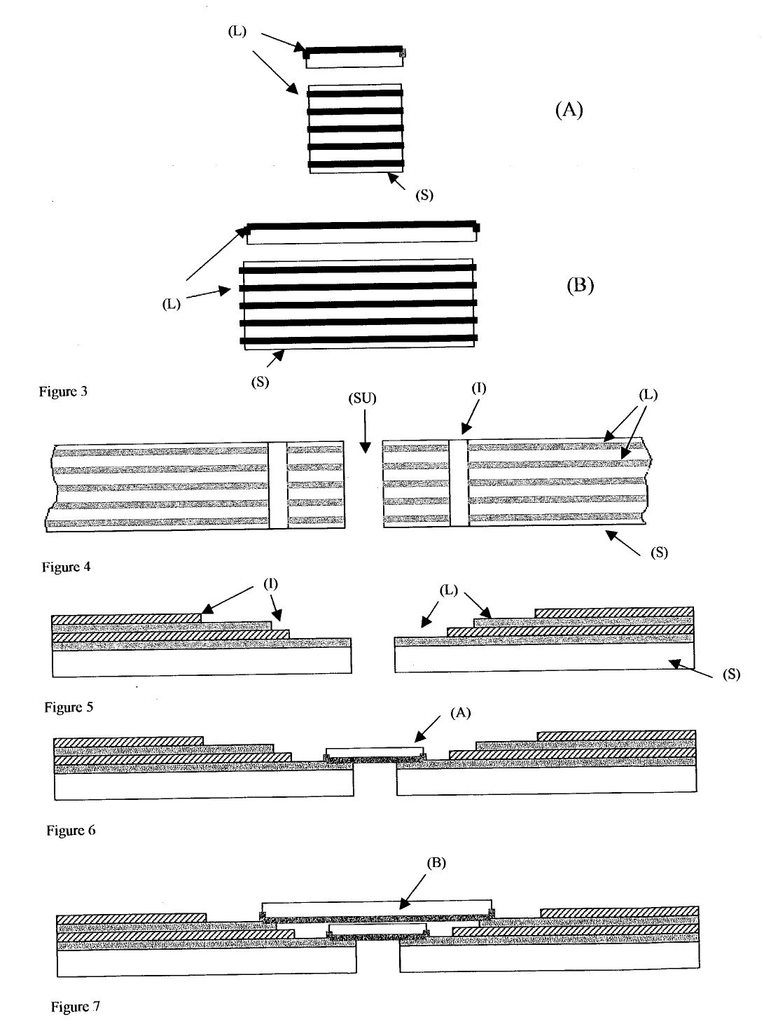

FIGS. 3 to 7 show examples of multilayer coils. FIG. 3 includes connecting parts of different size. FIG. 4 shows lead tracks (L) on a substrate (S) and in between the insulation layer (I). (SU) is the sawing track. FIG. 5 shows the cross section. In FIG. 6 one connecting piece is placed properly onto both ends of the lead tracks in FIG. 7 the second one as well.

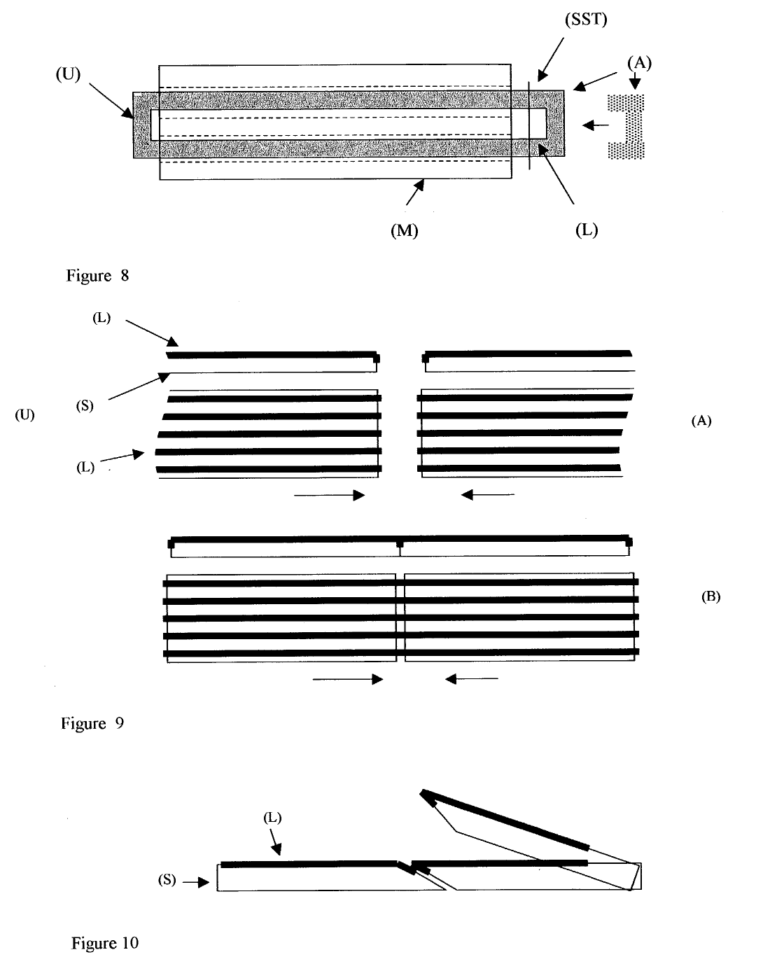

FIG. 8 shows an inductance, as e.g. a tranformer, with copper windings for the primary and the seondary side (L), consisting of section (B) and (A), which are electrically and mechanically connected at (SC).

FIG. 9: in this case the separated sections of the coil are completed by joining section (A) with section (U). The tracks are electrically connected at the face of the Substrate e.g. by pressure, temperature, vibration.

In FIG. 10 the plane of intersection is oblique. The metallized tracks cover also the oblique side. Segment (A) and segment (U) are electrically and mechanically connected by spring suspension and a bonding technique as above.

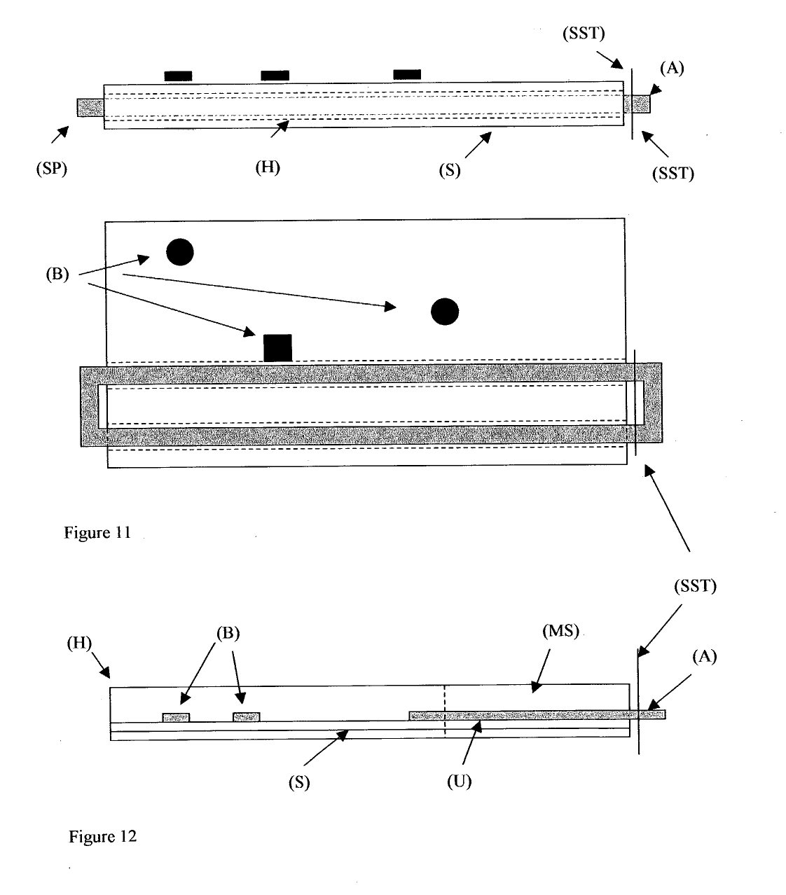

In FIG. 11 the magnetic core (H) [iron, magnetic ultrapure iron, NiFe alloys etc.] is an integrated part (moldet in etc.) of the substrate (S). One segment of the planar coil (SP) is inserted into the integrated magnetic core (H) [soft magnetic channel]. The coil ist electrically and mechanically connected with segment (A) at (SST).

(B) represent SMD components on the substrate, which can be placed above magnetic channel and electrical tracks as well.

In cases which tolerate higher values of the effective magnetic path length (e.g. due to the improved properties of the magneic circuit) the hollow body of the magnetic circuit can be used as package or heat sink as well (FIG. 12). (B)=various components; (H)=magnetic circuit and package and/or heat sink; (SP)=windings; (S)=substrate; (MS)=part of the package, used also as magnetic circuit (as shown in FIG. 11).

The described technique for the windings of inductive components is not limited to magnetic iron or ferrite. It allows also in a greater variety to use material with high permeability like e.g. NiFe—; CoFe-alloys, magnetic pure iron etc, which are marketed under names like Permanorm, Chronoperm, Mumetall and so on. For special applications tailored alloys and ferrites can now easily be handled.

Therefore the features of the material can be exploited better (because of new solutions without air gap and because of smaller dimensions).

For the inductive devices as described above the windings were on a conventional substrate (FIG. 2 and FIG. 11). However it is also possible to use a flexible foil.

The separated parts of the winding are conncted again at (SST). Due to longer wire leads of a loop in the magnetic circuit there are fewer windings necessary for a specific voltage. Therefore the windings may also be formed by using multi wire (e.g. 10 wires) jacketed in soft magnetic material (channel, pipe, molding tec.)

It is also possible to wind high permeable foils or tapes around wire leads which are electrically connected at e.g. (SST) in FIG. 8, so that they form the windings. The Primary etc. are connected to external pins.

Such design may be used for one wire, or for multi wires.

The cross section A of the magnetic circuit is determined by the very length of the wire loops and thus by the length of the soft magnetic channel or magnetic channels resp. and by the thicknes of the material. On the other hand the effective magnetic path length is very short. Both aspects are very helpful to get high induction.

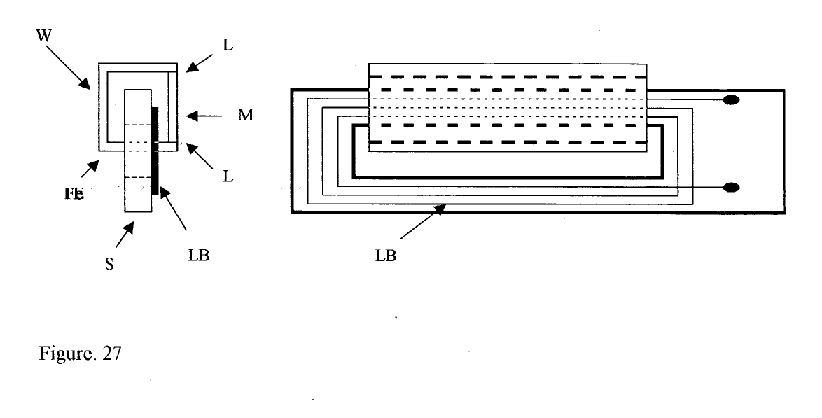

A similar design is shown in FIG. 27.

The costructural features allow it to make inductors with wire leads/conducting tracs (Cu, Ag, Au, Si, NCT's etc.) and a long but thin soft magnetic drain (W). The drain (e.g. of magnetic iron, or of strips of material of high permeability, ferrite) can be covered by soft magnetic material. Using connecting tracks on substrate (S) both sides of a certain section ob the tracks have to be free of material (tracks on bridge).

One of the advantages of such designs are that thin sheets for the magnetic circuit are sufficient which allow welding without exposing the usually more sensitive tracks (LB) to excessive temperaturse and nevertheless get inductors without air gap. A technique which is not possible using heavy E-cores etc. Another possibility are largly overlapping rims (drain) and cover sheets so that due to the large cross section (A) the magnetic circuit has a higher inductivity.

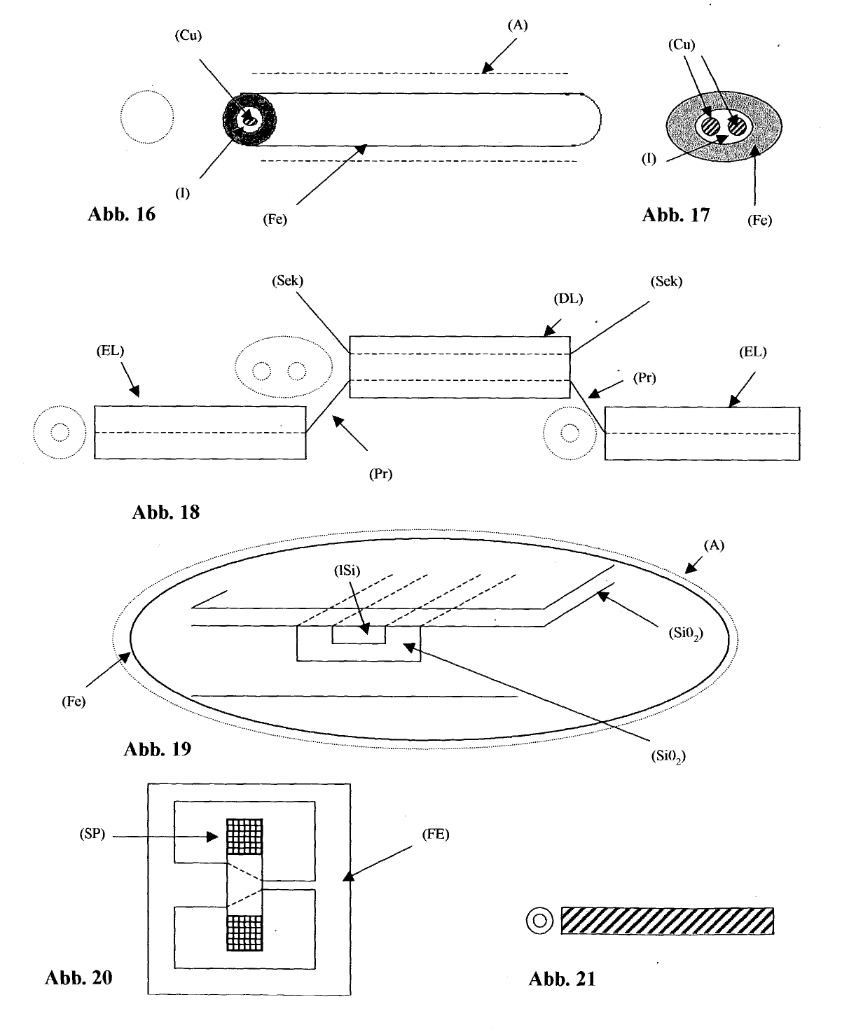

FIGS. 16 and 17: The wire is embedded in insolating material (I). In some cases however the insolation may be omitted e.g. if the wire has a better conductivity than the surrounding soft magnetic material.

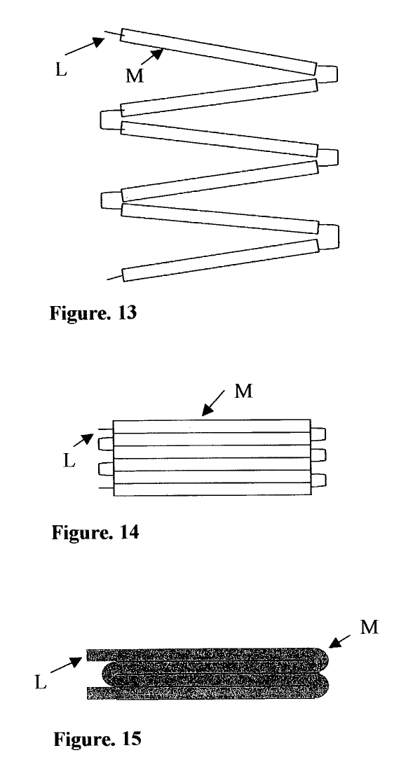

On the other hand it is possible to take coated wire leads (e.g. Si coated with SiO2) which form a solid unit with conducting material inside [e.g. FIG. 16 (Cu)] and insulating material (I) outside. More such leads can be combined to one unit (FIG. 16). Such insulated leads are then wrapped with soft magnetic material (or put into it) to form an inductive device. This way even smaller units are possible. FIG. 15 shows an exampel. The inductive unit (in form of a neander, a spiral or solid multiwire etc.) again, may be used as heat sink or part of the package as well.

FIG. 17 shows the cross section of such a two-wire (or a multi wire resp.) inductive component. FIG. 18 is a transformer with such leads. The lower wire leads represent the primary (the circles in the cross section represent X isolated wires), the upper the secondary. The magnetic circuit consists of 3 pipes (channels) like shown in FIG. 1. One of same total length however would do also.

FIG. 21 shows an example of how to make such pipes using strips of material with high permeability by winding it up. In contrast to pot cores such pipes (channels) are wound with a feed drive, which enable any length. Low feed results in pipes with overlapping material; high feed in spirals, e.g. for inductors with air gap.

Material of very high permeability may require a shilded [FIG. 16(A)] magnetic circuit (Fe) to avoid affects by external field.

In order to separate the windings and to put them together again it is usually easier to work with panar tracks which are in the following completed with the soft magnetic circuit (channel, pipe . . . ).

Inductors with air gap are possible by using a soft magnetic drain covered by soft magnetic strips, or using a spiral as described above. The inductance can be adjusted by mech. force to narrow the air gap.

Soft magnetic circuits without air gap can be used for motion as well, like e.g. for relays, lifting magnets, contactors etc.

FIG. 20 shows the principle construction.

The coil (SP) may be wound on a core or (as described above) it may be made by planar windings, which are separated into zwo or more parts, and electricalla and mechanically connected again. Thus very thin electromagnets are possible. (FE) is the solid magnetic circuit which is not spearated into yoke and armature. Such flat electromagnets can mechanically be operated in parallel or in series (more power and/or more shift).

The lifting magnets etc. can be designed with fixed coil or with a fixed magnetic circuit.

Inductive devices as described can be used for many applications such as:

transformers relays

power supplies plug in power supplies

lifting magnets loudspeaker

DC/DC converter yokes

standby circuits solar chargers etc.

B: Power Generators

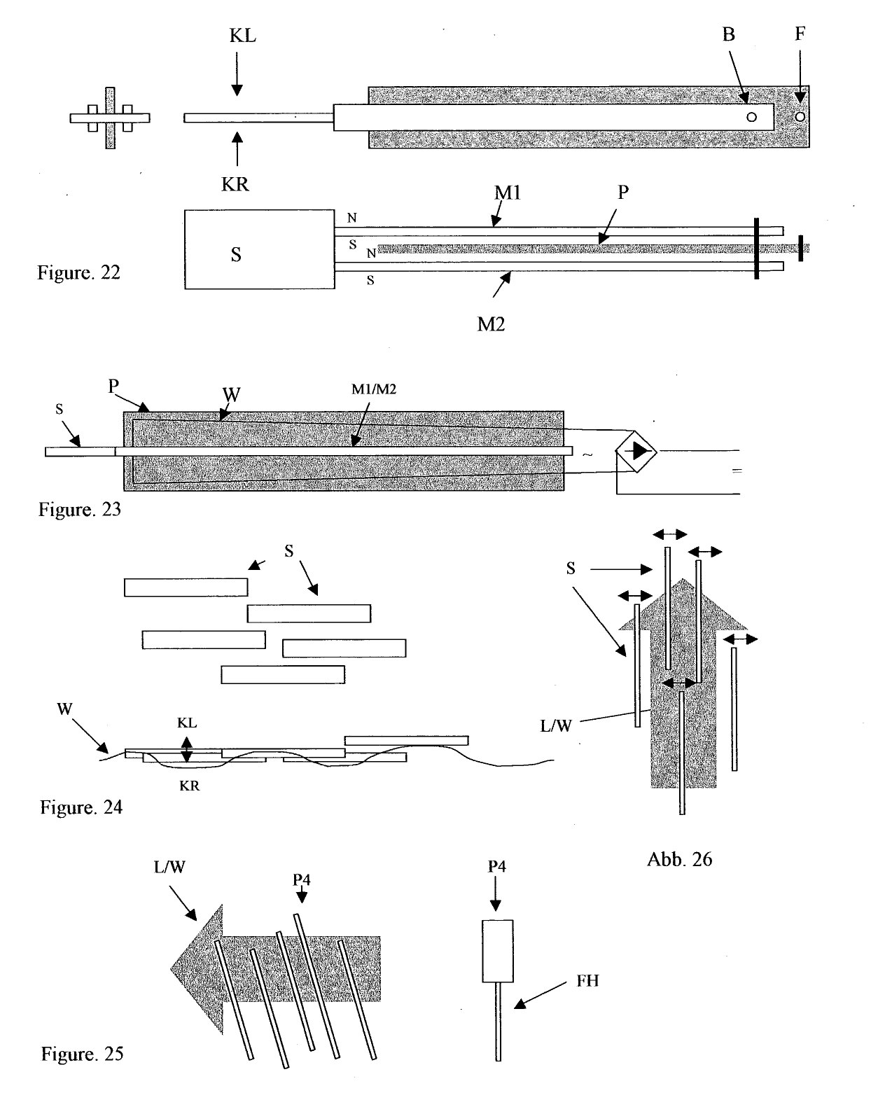

The above described inductive components used for load circuits can be considered as planar or as “streched” designs. Power generators can be designed on similar lines. FIG. 22 shows such a power generator. (M1) and (M2) are long permanent magnets with perpendicular magnetization (N and S in FIG. 22) which are joined to a float or a sail (S) resp. etc. Exposed to environmental forces they are moved forth and back. In order to get the desired motion, (M1) and (M2) are at least partially flexible or have on one side a suitable bearing so that it can be move like plants in the wind.

The tracks for the windings are on a longish substrate which is stiff and firmly fixed (B and F) e.g. to the ground. The permanent magnets have to pass the tracks in parallel. Due to the great length of the tracks stretched power generators require few windings only. Therefore it is not necessary to generate energy indirectly via rotation. One seesaw movement generates two pulses which may be recitified and converted etc. in the following.

Such generators work also with fixed permanent magnets and movable windings or with one movable magnet only.

FIG. 24 shows how to generate useful energy from water waves. Floaters (S), side by side, follow the water wave up and down and generate energy as shown in FIG. 22 by moving e.g. the permanent magnets. The floaters can be in a vertical or oblique position.

In a similar way (FIG. 25) flowing water (L/W) can be utilized. Paddles in a river e.g. are likewise moved forth and back.

The principle can be used in other media like air as well. In FIG. 25 sails (S) are moved by the wind (L/W) and generate energy as described (FIG. 22).

Another methode e.g. in water and air etc. is shown in FIG. 26. The paddles are almost in parallel to the current. Having a propper form, the paddels are constantly moved and generate energy as described.

Some of the advantages of the described solutions:

no rotation necessary

water (tide, waves etc.) can be utilized to generate energy without the need of a dam etc.

same possibility in low speed water etc.

same applies in air e.g. if the generators are set up an a hill (without tall wind power plants)

considerate solutions in the landscape

### BRIEF DESCRIPTION OF THE DRAWINGS

Drawing

1) Board with inductive devices as described and other SMD components.

2) Conducting tracs on substrates (2a), on a connecting part (2b). (2c show the connected tracs.

3) Connecting parts of different size.

4) Two layers of conducting tracs on substrates.

5) Cross section of it.

6) Lower conductors connected

7) Both conductors connected.

8) Planar channel inductive device with windings connectec at (SST).

9) The windings are connected at the face of the substrate.

10) Windings connectec using at the oblique frontage of a substrate.

11) Substrate with a planar channel inductive device and SMD components.

12) Cross section of it.

13) Flexible substrate with conducting tracs (L) on it in soft magnetic tubes (M).

14) Same foldet up.

15) Same with bent channels.

16) Insulated wird in soft magnetic tube.

17) Same with several wires.

18) Transformer consisting of wires (windings) in soft magnetic tubes.

19) Same with solid state wires and insulation in soft magnetic surrounding.

20) Lifing magnet without air gap.

21) Forming a magnetic tube by using material of high permeability.

22) Power generator with long effective wire length.

23) Cross section of it.

24) Principle of such a power generator for waves.

25) Principle of such a power generator in a stream of air or water etc.

26) Same in waves.

27) Windings fo connecting tracs or wires in a covered drain. Drain and cover e.g. of conventional magnetic material or of thin material of high permeability.

What is claimed is:

1. Inductive devices (coils, transformers etc.) which consist of soft magnetic tubes, channels or sleeves etc. for the magnetic circuit, which are relatively small in diameter, eventually thin walled but rather long and which (in contrast E—cores, Potcores etc.) are without air gap.

2. Inductive devices according to claim 1 with rel. long wire leads etc. inside rel. long soft magnetic channels etc.

3. Inductive devices according to claims 1 and 2 using magnetic iron, magnetic ultrapure iron, other material of high permeability like alloys, ferrites, iron molding componds etc.

4. Inductive devices according to claims 1 to 3 integrated into a substrate a semiconductor or moldet into a board etc.

5. Inductive devices according to claims 1 to 4 with solid conducting tracks in/on semiconductors like silicon or NTC 's etc. and which have one or more tracks insulated by oxidation etc. and which are mounted into a soft magnetic channel, pipe sleeve etc.

6. Inductive devices according to claims 1 to 5 where the board (with the other parts of the inductive device moldet in etc.) or housing resp. is also used as board or substrate for other components or as heat sink.

7. Inductive devices according to claims 1 to 6 where e.g. the primary winding or part of a winding serves at same time for other parts of the circuit, for auxiliary power supply, for standby operation etc.

8. Inductive devices according to claims 1 to 7 including several such units to form a multi inductive device.

9. Inductive devices according to claims 1 to 8 with windings (planar tracks in one ore more levels, wire leads etc.) which consist of 2 or more sections (with loops with one part on section 1 and the other part on section 2 etc.) and where the inductive device is asssembled by inserting one section of the windings into the soft magnetic tube, channel, sleeve etc. and then by completing the winding (loops) again by electrically connecting the wire or tracks etc. so that they form windings around one side of the magnetic circuit (soft magnetic tube, channel sleeve etc.), or where solid state units are separated und completed again accordingly.

10. Inductive devices according to claims 1 to 9 with air gap, using a soft magnetic-drain and a cover sheet or soft magnetic stripes wound up to form a spiral etc.

11. Inductive devices according to claims 1 to 11 with wire leads or conducting tracks inside soft magnetic material which can be mounted onto a board (or be moldet into it) or which is then foldet or wound up etc., e.g. for inductive stand alone components.

12. Inductive devices according to claims 1 to 11 working with tracks on foils substrates, wafers etc.

13. Inductive devices according to claims 1 to 12 with magnetic circuits using foils or strips etc. (magnetic iron, material of high permeability etc.) flat, or which are wraped around the leads or tracks with more or less feed or without to get the requested length and thus inductive value.

14. Pipes, sleevs etc. according to claim 13 which are used as a component as such with or without final heat treatment.

15. Inductive devices according to claims 1 to 14 with the wire leads or tracks in soft magnetic open drains which are (or are not) covered by soft magnetic sheets or foils for inductive devices with air gap. Same with the cover weldet etc. to the drain for units with a closed magnetic citcuit.

16. Inductive devices with closed magnetic circuit according to claims 1 to 15 and windings around one leg (which is e.g. conical) which are moved in respect to the magnetic circuit when the circuit with the windings is switched on.

17. Inductive component according to claim 16 with several units in parallel and/or in series to get higher power or more shift and/or with some of the magnets operated in opposite direction.

18. Inductive devices according to claim 1 and 3 to 8, 10, 12 synonymously with permanent magnets of small diameter but great length, and windings of similar lengths which can be moved between the magnets of opposite polarity or in respect to one permanent magnet and thus form a power generator were magnet and winding (leads or tracks etc.) pass each other fairly in paralles.

19. Induktive power generators according to claim 18 where the movable part (magnets or windings) is joind to a floater, a paddle, a seil etc, so that environmental forces as e.g. air, water (flowing water, waves etc.) move the windings or the magnets resp. and generate so electical energy in the winding.
